(19) United States
(12) Patent Application Publication
(10) Pub. No.: US 2016/0292247 A1
(43) Pub. Date: Oct. 6, 2016

(54) METHOD OF RETRIEVING CATEGORICAL DATA ENTRIES THROUGH AN INTERACTIVE GRAPHICAL ABSTRACTION

(71) Applicant: Kenneth Scott Kaufman, Carlsbad, CA (US)

(72) Inventor: Kenneth Scott Kaufman, Carlsbad, CA (US)

(21) Appl. No.: 14/673,871

(22) Filed: Mar. 31, 2015

(51) Int. Cl. G06F 17/30; G06F 3/0484; G06F 3/0482

(52) U.S. Cl. CPC G06F 17/30572; G06F 17/30327; G06F 17/30339; G06F 3/0482; G06F 3/04842; G06F 17/30601

(57) ABSTRACT

A method of retrieving categorical data entries through an interactive graphical abstraction employs a generate categorical post entries process and a load categorical post entries process. Through the generate categorical post entries process, post entries generated by a user are automatically associated in a user post entry database table with a specific BranchID value of which the posting user is the OwnerUserID, thereby enabling retrieval thereof. Through the loading categorical post entries process, a user a desired branch of a an interactive graphical abstraction on a graphical user interface, thereby causing each post entry in the database from a user on the branch selected by the user through the interactive graphical abstraction to be pulled for display or storage.

### BRIEF DESCRIPTION OF THE DRAWINGS

FIG. 1 is an exemplary entity relation diagram showing the relationship between the basic tables of a database for use with a method of retrieving categorical data entries through an interactive graphical abstraction.

FIG. 2 shows an exemplary table of user entries in a database for use with a method of retrieving categorical data entries through an interactive graphical abstraction.

FIG. 3 shows an exemplary table of branch type entries in a database for use with a method of retrieving categorical data entries through an interactive graphical abstraction.

FIG. 4 shows an exemplary table of branch id entries in a database for use with a method of retrieving categorical data entries through an interactive graphical abstraction.

FIG. 5 shows an exemplary table of user branch entries in a database for use with a method of retrieving categorical data entries through an interactive graphical abstraction.

FIG. 6 shows an exemplary table of user post entries in a database for use with a method of retrieving categorical data entries through an interactive graphical abstraction.

FIG. 7 shows a graphical representation of an exemplary user selection in the loading categorical post entries process for a method of retrieving categorical data entries through an interactive graphical abstraction.

FIG. 8 shows a database representation of an exemplary branch to user association step in the loading categorical post entries process for a method of retrieving categorical data entries through an interactive graphical abstraction.

FIG. 9 shows a database representation of an exemplary branch to owner user association step in the loading categorical post entries process for a method of retrieving categorical data entries through an interactive graphical abstraction.

FIG. 10 shows a database representation of an exemplary categorical post retrieval step in the loading categorical post entries process for a method of retrieving categorical data entries through an interactive graphical abstraction.

FIG. 11 is a flow chart showing the steps in the loading categorical post entries process for a method of retrieving categorical data entries through an interactive graphical abstraction.

FIG. 12 shows a graphical representation of an exemplary user selection in the generate categorical post entries process for a method of retrieving categorical data entries through an interactive graphical abstraction.

FIG. 13 shows a database representation of an exemplary categorical post generation step in the generate categorical post entries process for a method of retrieving categorical data entries through an interactive graphical abstraction.

FIG. 14 is a flow chart showing the steps in the generate categorical post entries process for a method of retrieving categorical data entries through an interactive graphical abstraction.

### DETAILED DESCRIPTION OF THE INVENTION

A method of retrieving categorical data entries through an interactive graphical abstraction in accordance with the present invention is employed in the preferred embodiment in a social media platform to streamline the processing of a user's initiation of communication operations between the user and the contacts of that user. A user's initiation of social interactions by contact classification is typically implemented on a personal computer system, such as a mobile computer/smart phone, and a server, each of which would typically include a processor unit(s), a non-transitory computer-readable medium, an input interface(s) (such as a mouse, keyboard, or touch screen), a display device(s)(such as a monitor), and a networking interface(s). In the preferred embodiment, the computer-readable mediums includes a computer program(s) stored thereon that defines a set of instructions that, when executed by the processor unit, cause the processor units to perform the underlying process operations of the method for initiating social interactions by contact classification over the input, display and networking interfaces.

It is appreciated that conventional online social media platforms, particularly social networking sites, generally allow users to, among other things, form virtual associations with one another and engage in virtual social interactions with other users, such as sharing original messages/content or sharing linked content. It is common for users of social networking sites to form tens, hundreds, or thousands of virtual associations with other users (for ease or reference, the other users with whom a first user has a virtual association with are referred to herein as “contacts,” “friends” or “connections” of that user) and for that user to transmit messages or data with individual contacts or collections of contacts on a regular basis. As social media networks grow to encompass millions of members, the relationships and preferences between members often create exceptionally large computational loads to manage, thus consuming gargantuan computer cycles to process.

The instant invention is operative to capture and store member information and social interaction preferences using a data model that creates a more efficient means for storing, displaying and processing such data. The solutions for managing such interaction have been specifically designed around the graphical abstraction requirements resulting in a significant reduction in computer processing requirements to display such data.

As performance is a primary consideration in choosing a social media network the tying of the graphical abstraction of relationships to the storage and retrieval mechanism results in a unique solution to this complex set of problems. To demonstrate the efficiencies of a graphical representation based data model created by the instant method of improving retrieval, a benchmark comparison of the graphical representation based data model and the data model of a traditional social network was created. 50,000 concurrent users, encompassing 875,348 branches or groups, 1,250,745 unique friends, 2,973,083 friends on branches/groups and 1,250,412 member posts were loaded and the queries necessary to extract this data from the two models on same server were run. The results was a 293% improvement in processing efficiencies using the graphical representation based data model relative to the. traditional data model, validating the anticipated improvement.

The instant method operates through a tree graphical abstraction generated from a database. Thus, the same the graphical abstraction used to display each of a user's contacts, categorized hierarchically, is used to initiate social interactions to be directed to contacts. Accordingly, the retrieval of categorical data entries through an interactive graphical abstraction, employed to both initiate and limit message or information distribution, enables direct access to data without the processing loads of other designs.

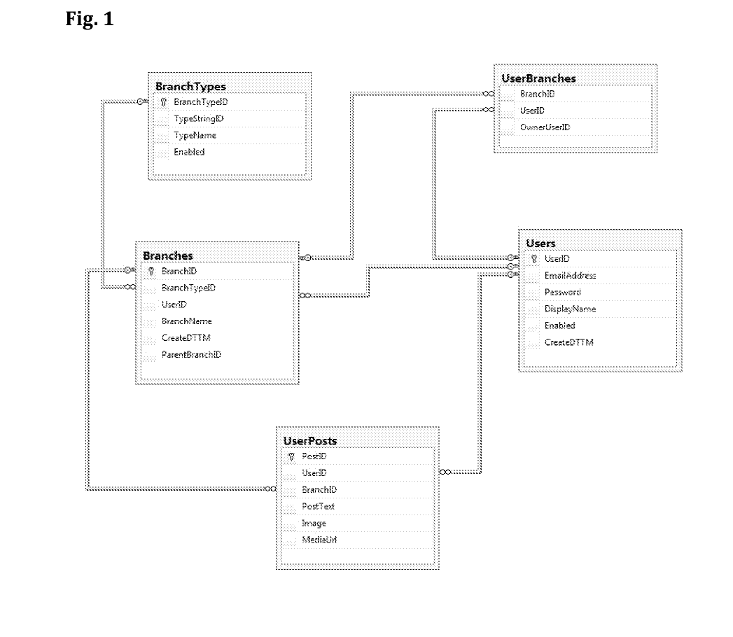

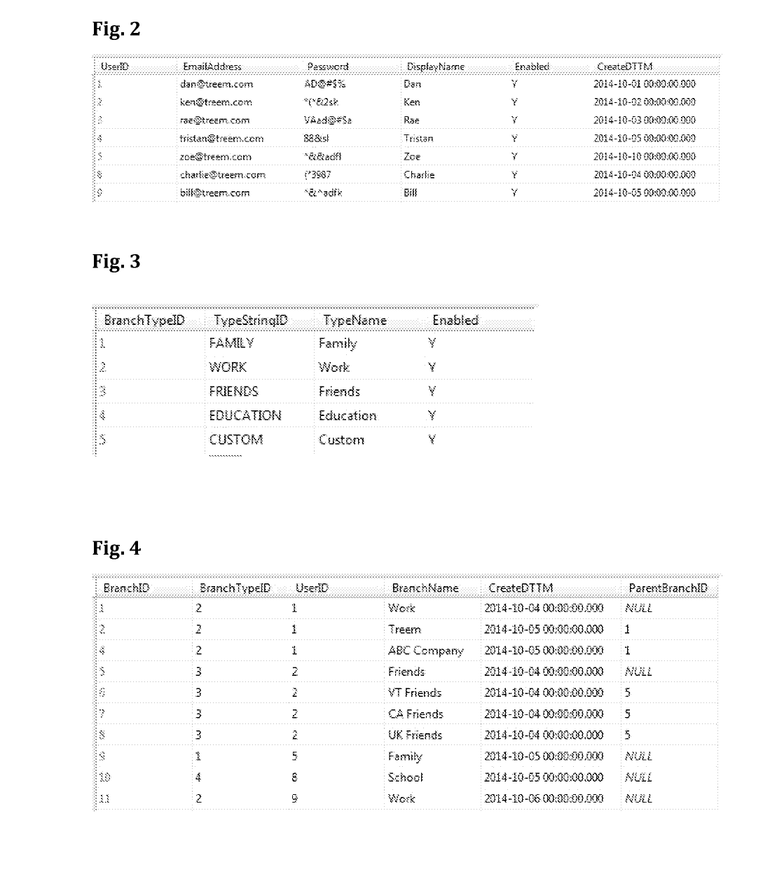

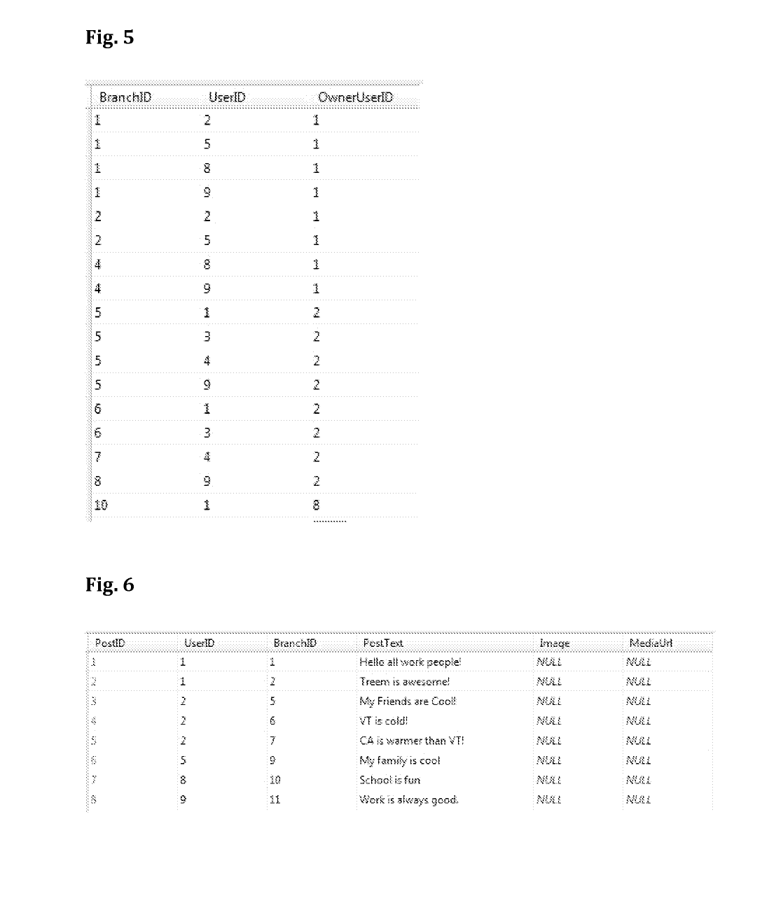

Referring now to the drawings and in particular FIGS. 1-6, it is contemplated that in the relevant social media platform, account information for a user's contacts will likely be stored in tables and a database model designed around the tree graphical abstraction, defined in one embodiment as an object oriented database model. Thus, for a social networking site, it is contemplated that each of a first user's contacts will be stored in a various linked database tables, such as user entries, branch type entries, branch id entries, user branch entries, user post entries. Under the object oriented database implementation of the tree graphical abstraction database model, the tables are linked through primary keys (“PK”) and foreign keys (“FK”) as follows: Users: UserID—PK; BranchTypes: BranchTypeID—PK; Branches: BranchID—PK, BranchTypeID—FK to BranchTypes PK, UserID—FK to Users PK; UserBranches: BranchID—FK to Branches PK, UserID—FK to Users PK, OwnerUserID—FK to Users PK; UserPosts: PostID—PK, UserID—FK to Users PK, BranchID—FK to Branches PK.

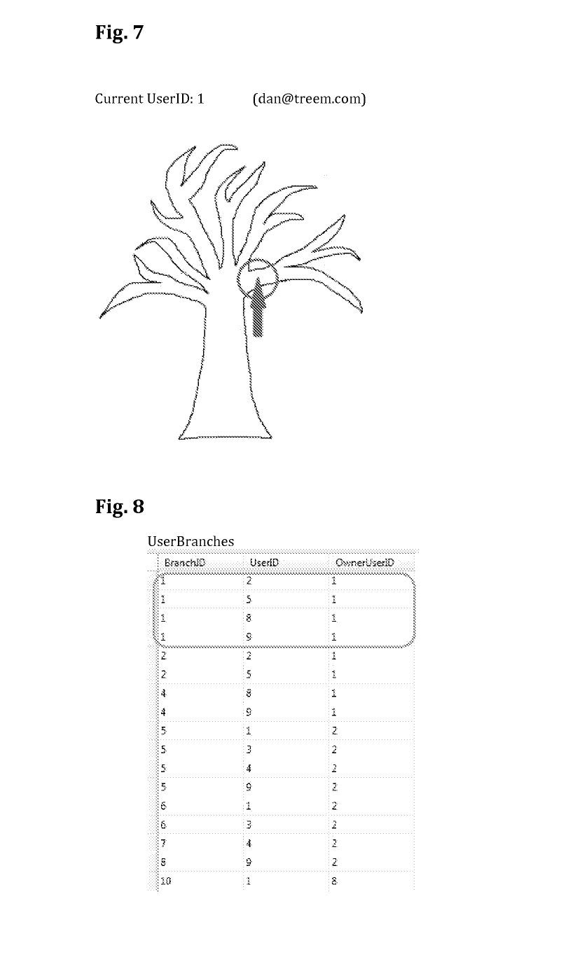

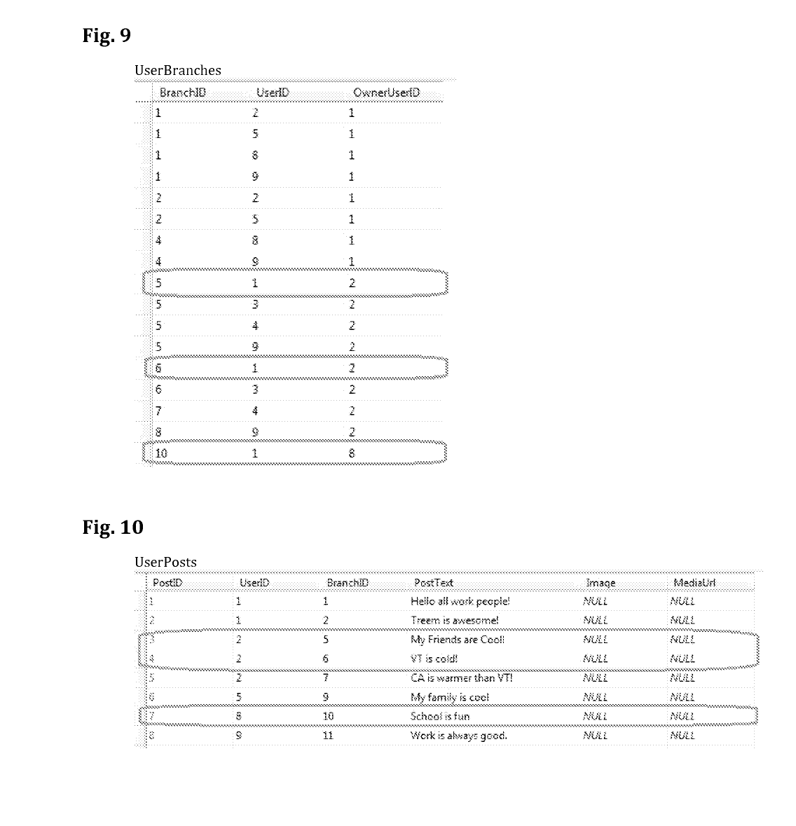

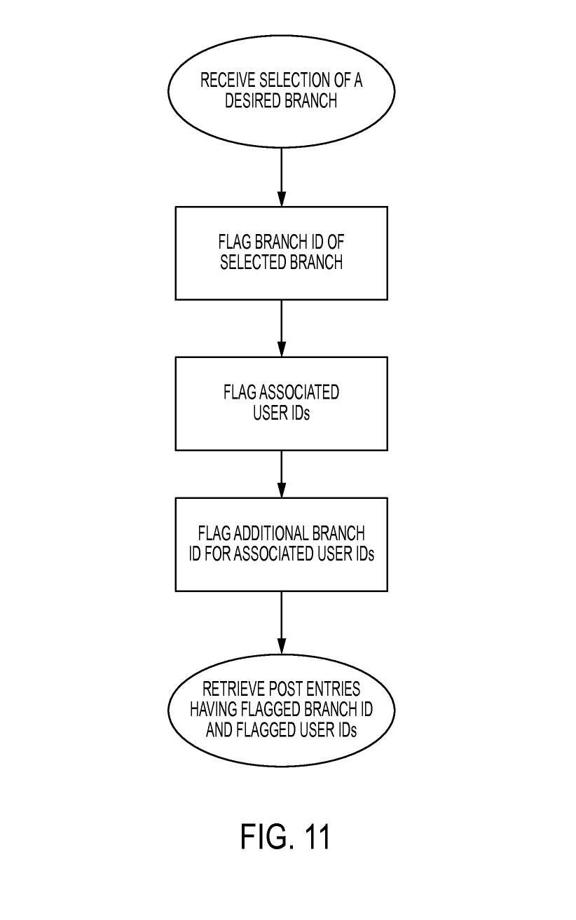

Referring now to FIGS. 7-11, in the preferred embodiment, the visually represented hierarchy of a categorization of a user's contacts defines a graphical abstraction of a tree. Accordingly, an interactive classification tree, as exemplified by FIG. 7, is generated for a user on a graphical user interface to allow a user to select contacts by category. It is contemplated that a classification tree generation process may be employed to populate the graphical abstraction of a tree so that each branch in the abstraction can represent a both a specific BranchID, as a unique identifier for the branch in the abstraction, as well as a BranchTypeID that represents the branch's place in the categorization hierarchy, so as to allow the branch to be positioned relative to other branches in the tree abstraction.

A user interacts with the tree abstraction by selecting a branch for which the user desires information. Exemplified in FIG. 7-10 is a loading categorical post entries process. A user first would select the desired branch on the graphical user interface on connected to the computer system on which the method of retrieving categorical data entries through an interactive graphical abstraction. Then, the system identifies and flags the BranchID that corresponds to the selected branch in the user branch entries table. The system then flags each UserID for the flagged BranchID. Next, the system additionally flags each BranchID wherein (1) the OwnerUserID matches a flagged UserID and (2) the UserID is equal to the current user (exemplified for UserID number 1). From the user post entries table, the system then retrieves each post entry that has a flagged UserID and BranchID, thereby pulling for display or storage each post entry from a user on the branch selected by the user through the interactive graphical abstraction.

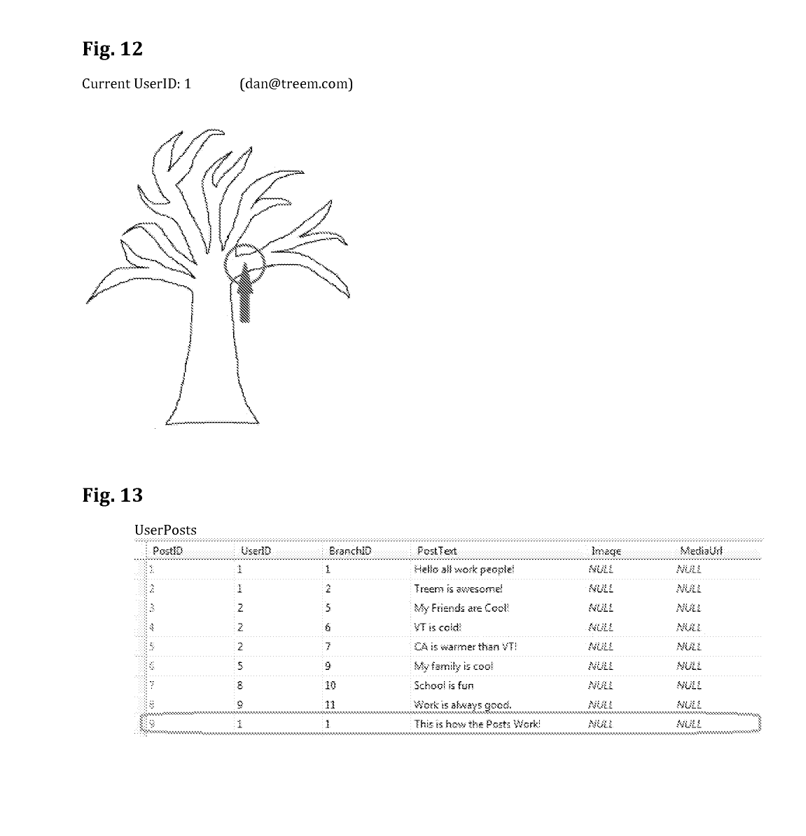

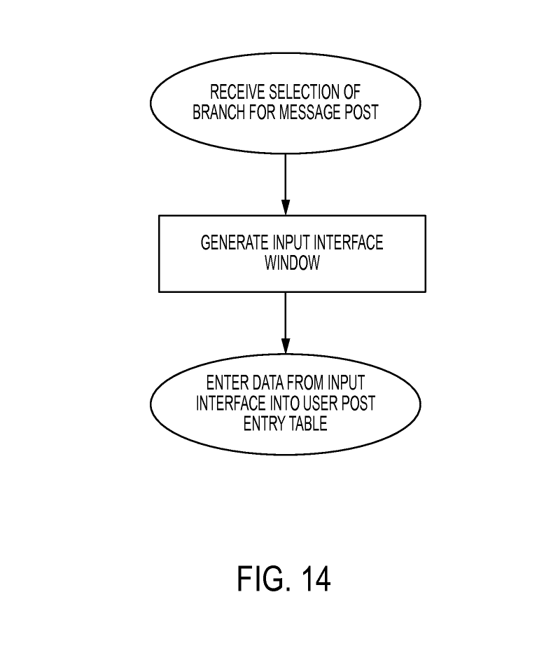

Referring now to FIGS. 12-14, in the preferred embodiment, when post entries are generated by a user in the method of retrieving categorical data entries through an interactive graphical abstraction, they are associated with a specific BranchID value of which the posting user is the OwnerUserID (meaning the UserID of the posting user equals the OwnerUserID for the particular branch). Thus, when a first user (defined by the user with the UserID value of 1) wants to create a new post entry containing text, an image, a link, or other social media content, the first user begins by selecting the branch in the abstraction to which it is desired the post is associated. Once a branch has been selected, a post entry window provides an interface in which the first user can enter the information related to his post. The information received is entered by the system on which the method of retrieving categorical data entries through an interactive graphical abstraction, which stores it as a new entry in the user post entries table. As the new post entry includes the UserID value of the posting user and the BranchID value of the category the posting user selected to enter the new post, the user post entries table is automatically maintained to enable the new post entry to be retrieved in accordance with the loading categorical post entries process when its UserID value and BranchID value dictate it.

It is contemplated that the graphical abstraction of the tree provides a graphical interface through which a user can initiate social interactions in a social media platform, such as a social networking site, with their contacts by classification/category as opposed to by name (or other individual identifier). The tree abstraction generation process is operative to generate the graphical representation of the user's contacts in a hierarchical format from our tree graphical abstraction database tables so that the various categorization of contacts are more readily distinguishable. In addition, the tree abstraction generation process enables the use of the same relational data model that generates the graphic representation to be used to manage the processing of the algorithmic aggregation. In the preferred embodiment, the data is stored in both production tables and archive tables, as managed by a data archiving model that systematically moves data from production tables to archive tables as needed. Coordination the instant method, in conjunction with these models, is a data aggregation algorithm that, using the concept of the tree graphical abstraction in its design to store and retrieve data, allows for direct access to data without the processing loads of other designs. Advantageously, the data aggregation algorithm is additionally operative to recognize when data needs to be pulled from an archive tables so as to achieve further reductions in database size and processing requirements.

It is understood that when the tree abstraction is generated, any discrete contact entry associate with more than one BranchID value will be represented in multiple places on the tree abstraction.

It is further understood that the method of retrieving categorical data entries through an interactive graphical abstraction may be employed to enable retrieval of other entry types from tables other than the user post entries table, including to retrieve entries containing contact information, recent activity, or general categorization.

The present invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method of retrieving categorical data entries through an interactive graphical abstraction in a social media platform through a graphical interface, comprising the steps of:
providing to a computer system a database containing linked tables, said database including entries organized by at least UserID values, BranchID values, and OwnerUserID values as well as including data from entries related to user action, UserID, BranchID, and OwnerUserID;
generating by the computer system a graphical abstraction of a tree having at least one branch that visually represents a categorization hierarchy of a user's contacts, wherein said at least one branch in the abstraction represents a both a specific BranchID, as a unique identifier for the branch in the abstraction, as well as a BranchTypeID that represents the branch's place in the categorization hierarchy;
receiving by the computer system an input that selects at least one branch in the abstraction;
flagging by the computer system the BranchID value that corresponds to the selected branch; and
flagging by the computer system each BranchID wherein (1) the OwnerUserID matches a flagged UserID and (2) the UserID is equal to the current user.

2. The method of claim 1, additionally comprising the step of retrieving by the computer system the data from entries related to user action that has a flagged UserID and BranchID

3. The method of claim 2, wherein said data from entries related to user action defines data from a UserPosts table.

4. The method of claim 2, additionally comprising the step of displaying retrieved data from entries related to user action.
